(19) United States
(12) Patent Application Publication
(10) Pub. No.: US 2007/0113231 A1
(43) Pub. Date: May 17, 2007

(54) Multi processor and task scheduling method

(75) Inventor: Tetsuroo Honmura, Sagamihara (JP)

Correspondence Address: MILES & STOCKBRIDGE PC, 1751 PINNACLE DRIVE, SUITE 500, MCLEAN, VA, 22102-3833, US

(73) Assignee: Hitachi, Ltd.

(21) Appl. No.: 11/591,612

(22) Filed: Nov. 2, 2006

(30) Foreign Application Priority Data
Nov. 11, 2005 (JP) 2005-327127

(51) Int. Cl. G06F 9/46

(52) U.S. Cl. 718/100

(57) ABSTRACT

A multi processor (107) includes a plurality of processor elements (103, 104, 105) and has a processing portion (210) capable of executing an application software and serving to carry out a process for determining a task to be assigned to the processor elements at a request given from the application software. The processing portion determines the task to be assigned to the processor elements at the request given from the application software. For task scheduling in the multi processor, consequently, it is possible to enhance a flexibility for an application software.

### CLAIM OF PRIORITY

The present application claims priority from Japanese application JP 2005-327127 filed on Nov. 11, 2005, the content of which is hereby incorporated by reference into this application.

### FIELD OF THE INVENTION

The present invention relates to a technique for extracting a parallel property of a program and carrying out a task division and arrangement which is suitable for each of processors in a multi processor constituted by the processors and, for example, an effective technique for an application to scheduling in a heterogeneous multi processor.

### BACKGROUND OF THE INVENTION

In a microprocessor according to an example of a semiconductor integrated circuit, an increase in a speed of a calculation process has been limited due to a limitation of an operating frequency (a clock frequency) with a microfabrication and an increase in a power. In a heterogeneous multi processor obtained by integrating a plurality of processors into one chip, therefore, attention has been paid to a technique for causing a process to be parallel.

A multi processor has been developed for large scale calculating machines and personal computers. In that case, a plurality of processors is of the same type. On the other hand, the heterogeneous multi processor is constituted by arranging a plurality of different processors in one chip, and a smaller area and a lower power are intended with an incorporated system set to be a target and an optimum combination of the processors is investigated corresponding to a process to be managed.

The heterogeneous multi processor has an advantage that a process efficiency is high. In order to make the most of the advantage, any processor element (PE) to which an application software process is assigned is important. The assignment of the process is carried out by an OS (Operating System). The operating system (OS) carries out a sequential assignment every process unit referred to as a task. Therefore, the assignment of the process to the processor element will be referred to as “task scheduling”.

In the task scheduling, it is important to properly assign a task to a processor element based on a request of the application software. It is hard to manually carry out the task scheduling for the following reasons.

For a first reason, trade-off of the application software request is to be taken into consideration. The application software request is related to a request which can be implemented by a software after a structure of a multi processor is determined, and includes a real-time constraint that a process is ended within a certain time and a power constraint that a whole multi processor is held in a constant power. The real-time constraint and the power constraint have a relationship of the trade-off. An observance of the real-time constraint can be achieved with an enhancement in a performance. Therefore, an operating frequency can be enhanced, for example. On the other hand, an observance of the power constraint can reduce the operating frequency. In manual consideration of the trade-off, it is hard to implement optimum scheduling.

For a second reason, a hard resource to be a heterogeneous processor element is to be taken into consideration because the heterogeneous multi processor is intended. More specifically, because of the heterogeneous processor element, a performance factor such as a latency or a throughput is varied and a dependency on an assignment to any process is a cause. Moreover, these performance factors also influence a timing of data between the processor elements. In the manual consideration of a large number of factors, it is hard to implement optimum scheduling.

For the reasons, a compiler for automatically determining the scheduling has been studied (for example, see Non-Patent Document 1). In respect of the schedule of a task of a whole multi processor, moreover, there has been known a technique for taking a power into consideration (see Patent Documents 1 and 2).

[Patent Document 1] JP-A-2002-202893 Publication

[Patent Document 2] JP-A-2004-199139 Publication

[Non-Patent Document 1] H. Honda, H. Kasahara, S. Narita, and S. Mizuno, “Parallel Processing Scheme of a Basic Block in a Fortran Program on OSCAR”, Systems and Computers in JAPAN, Vol. 22, No. 11, pp. 1-13, 1991

### SUMMARY OF THE INVENTION

The inventor has investigated the conventional art. As a result, it has been found that an improvement can be carried out for the following two respects in terms of a flexibility for an application software request because scheduling is determined statically before an execution of a system.

First of all, a flexibility lacks after a system apparatus is shipped or when an identical application software is to be loaded onto the different system apparatuses. In recent years, a highly functional application software such as a car or information household appliances also has a product lifetime which is prolonged. In some cases, an application software request is changed after the shipment of the system apparatus. In particular, it can be sufficiently considered that a performance request is increased. Moreover, it can be expected that a popular application software such as a digital terrestrial television broadcasting is mounted on various apparatuses such as a car navigation system, information household appliances and a cell phone. Requests for an LSI and application software are necessarily varied depending on apparatuses on which they are mounted. For these two cases, it is desired that task scheduling can be changed easily by a control of a software in order to guarantee a flexibility on a system apparatus manufacturer side.

Secondly, dynamic scheduling is required when an application software request cannot be satisfied in accordance with an original budget due to a dynamic factor. The dynamic factor includes a data dependency represented by an application software of a multi media system. Also in such a case, it is desired that the task scheduling can be changed easily.

It is an object of the invention to provide a technique for enhancing a flexibility for an application software in task scheduling in a multi processor.

The above and other objects and novel features of the invention will be apparent from the description of the specification and the accompanying drawings.

A typical summary of the invention disclosed in the application will be briefly described below.

In a multi processor system including a plurality of processor elements and capable of executing an application software by the processor elements, there is provided a processing portion for carrying out a process for determining a task to be assigned to the processor elements at a request given from the application software.

The processing portion determines the task to be assigned to the processor elements at the request given from the application software. This achieves an enhancement in a flexibility for the application software in task scheduling in the multi processor.

In a multi processor including a plurality of processor elements and capable of executing an application software by the processor elements, there are provided a plurality of tasks in which assignments of processes to the processor elements are different from each other, and a task manager for selecting a task corresponding to a request given from the application software from the tasks.

The task manager selects the task corresponding to the request given from the application software from the tasks. This achieves an enhancement in a flexibility for the application software in the task scheduling in the multi processor.

In this case, it is possible to have a structure that there are provided a task management table including the task, a sub-task constituting the task, a budget of an execution time of the sub-task and an evaluation result, and a hardware parameter having a hardware code for implementing the sub-task and an operating frequency, and a hardware model including a substance of the hardware parameter and information about a correlation between the hardware parameter and the execution time, and the task manager carries out task scheduling based on the task management table and the hardware model in that case.

Moreover, it is possible to have a structure in which the task manager decides an implementability based on the task management table and the hardware model table after a change of the task based on the request given from the application software and changes the hardware parameter or carries out a change to a task having a lower task priority than a current task if it is decided that the request given from the application software is not satisfied in the decision.

A task scheduling method in a multi processor capable of executing a software process of an application software on a unit of a task by an assignment to a plurality of processor elements, comprises the step of changing an assignment of a task assigned to the processor elements based on a task priority table indicative of a task priority for the tasks.

According to the means, the assignment of the task assigned to the processor element is changed based on the task priority table indicative of the task priority for the tasks. This achieves an enhancement in a flexibility for the application software in the task scheduling in the multi processor.

In this case, it is possible to have a structure in which the task priority table includes a hardware parameter for executing the task together with task priority information for the tasks.

It is possible to have a structure in which whether an execution time request is satisfied is decided by using a task management table for a task management and a hardware model table for hardware model information, and a hardware parameter for implementing an execution time which is demanded is recalculated by using the task management table and the hardware model table corresponding to a result of the decision.

It is possible to have a structure in which there is selected, as a new task, a change of a hardware parameter having a first task priority based on the task priority table if a request for an execution time is changed during an execution of the task having the first task priority, or a task having a second task priority or less which is selected and an execution to be achieved by the hardware parameter if the selection of the task having the second task priority or less and a change of a parameter of a hardware to execute the task satisfy an application software request.

It is possible to have a structure in which when an execution time request of an application software is defined on a process data unit, a time exceeding a first budget is subtracted from an original budget with respect to a second task to determine a task execution time so as not to exceed a budget of a task for a next second process data unit if an execution of a check point of a task exceeds the budget for a first process data unit based on a task check point table holding a middle check point of the task and a budget of the check point.

When the application software is executed by the multi processor including a plurality of processor elements, a first process and a second process are provided in a complier capable of carrying out the scheduling for the task at a request given from the application software. The first process decides whether an execution time request value for the task can be implemented based on various tables every processor element or not and decides whether a data transfer maximum capability of a hardware for carrying out only the data transfer is exceeded or not. In the second process, the task candidate management table is output as a task management table based on a result of the decision in the first process. The various tables include a module table, the task candidate management table, a hardware operation model table and a task candidate task priority table.

The module table includes information about a module obtained by subdividing the application software, a flag indicating whether input data to be processed by the module can be divided and processed in parallel, and a module of a data transfer amount of the input/output of the module and a data transfer destination.

The task candidate management table includes a task candidate constituted by selecting the module as a sub-task candidate and combining a hardware code and a hardware parameter which are utilized by the sub-task, an estimated value of an execution time for the sub-task applying the same, and the sub-task with each sub-task candidate.

The hardware operation model table has a substance of the hardware code in the multi processor to be utilized by the sub-task candidate, a hardware model representing a correlation between the hardware parameter and the execution time, and a data transfer maximum capability for a hardware to carry out only a data transfer.

The task candidate task priority table has candidates of a hardware parameter for specifying any of the task candidates to which a task priority is to be given and executing the task candidate and minimum and maximum values of a task execution time when a first task candidate to be assigned to a first processor element and to be executed and a second task candidate to be assigned to a second processor element which is different from the first processor element and to be executed are present in the task candidate management table, and candidates of an execution time request value for the task and a hardware parameter corresponding thereto.

### BRIEF DESCRIPTION OF THE DRAWINGS

FIG. 1 is a block diagram showing an example of a structure of a main part in a car navigation system apparatus constituted by mounting a heterogeneous multi processor according to an example of a semiconductor integrated circuit in accordance with the invention,

FIG. 2 is an explanatory diagram showing a summary of dynamic scheduling in an execution of an application software in the multi processor,

FIG. 3 is an explanatory diagram showing a data flow in an MPEG decoder according to an example of the application software,

FIG. 4 is an explanatory diagram showing the case in which the MPEG decoder illustrated in FIG. 3 is implemented by the heterogeneous multi processor,

FIG. 5 is a timing chart showing a task control in the structure illustrated in FIG. 4,

FIG. 6 is a timing chart showing the task control in the structure illustrated in FIG. 4,

FIG. 7 is an explanatory chart showing an execution plan in the MPEG decoder,

FIG. 8 is an explanatory chart showing an executing estimation obtained when a real-time budget is exceeded in the MPEG decoder,

FIG. 9 is an explanatory chart showing a new executing plan which is dynamically determined when an audio decoder exceeds the real-time budget in the MPEG decoder,

FIG. 10 is an explanatory diagram showing an internal process of the audio decoder in the MPEG decoder,

FIG. 11 is an explanatory diagram showing an assignment of a task for executing the process in FIG. 10 in parallel onto the heterogeneous multi processor,

FIG. 12 is a timing chart showing a task control to be carried out when the audio decoder in the MPEG decoder is executed in parallel,

FIG. 13 is an explanatory diagram showing a process in a task manager,

FIG. 14 is a flowchart showing the process in the task manager,

FIG. 15 is an explanatory diagram showing an example of a structure of a control register for controlling the task,

FIG. 16 is an explanatory diagram showing an example of a structure of a state register indicating a state of the task,

FIG. 17 is an explanatory diagram showing a definition of the task and an ID,

FIG. 18 is an explanatory diagram showing a hard model to be utilized by the task,

FIG. 19 is an explanatory diagram showing a performance limit of a bus in the heterogeneous multi processor,

FIG. 20 is an explanatory diagram showing a task management table included in the heterogeneous multi processor,

FIG. 21 is an explanatory diagram showing a new task management table for an irregular state in the heterogeneous multi processor,

FIG. 22 is an explanatory diagram showing a task management table for an OS in the heterogeneous multi processor,

FIG. 23 is an explanatory diagram showing a check point of a task in the heterogeneous multi processor,

FIG. 24 is a flowchart showing a procedure for creating a complier for generating the task management table, other tables and programs,

FIG. 25 is an explanatory diagram showing a task priority table in the heterogeneous multi processor,

FIG. 26 is a flowchart showing a process of changing the task management table with a variation in the task priority table,

FIG. 27 is an explanatory diagram showing a task priority table changed in the heterogeneous multi processor,

FIG. 28 is an explanatory diagram showing a task management table changed in the heterogeneous multi processor, and

FIG. 29 is an explanatory diagram showing information to be used in a task check.

### DETAILED DESCRIPTION OF THE PREFERRED EMBODIMENTS

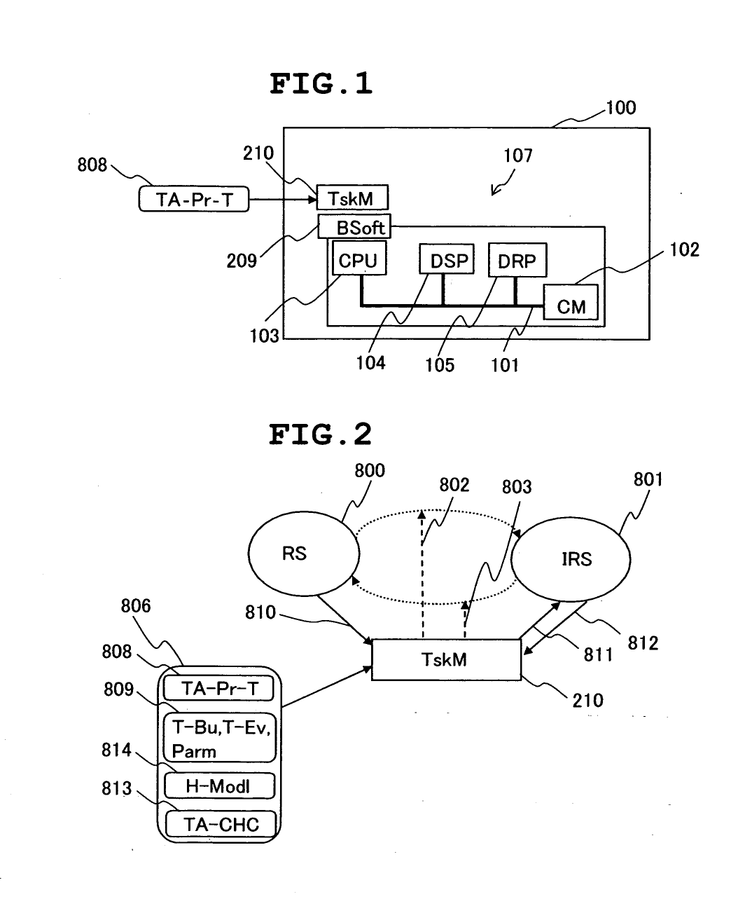

FIG. 1 shows a car navigation system apparatus constituted by mounting a heterogeneous multi processor according to am example of a multi processor in accordance with the invention. A car navigation system apparatus 100 shown in FIG. 1 serves to lead a car to a destination and includes a heterogeneous multi processor 107 for carrying out various calculation processes therefor. The heterogeneous multi processor 107 can flexibly correspond to the case in which an application software request is changed after a system apparatus is shipped or when the same application software is to be loaded onto different system apparatuses. By dynamic scheduling, moreover, a budget observance can be carried out as greatly as possible and quality of a service can be enhanced.

First of all, description will be given to a summary of a kernel portion of the heterogeneous multi processor 107.

The heterogeneous multi processor 107 shown in FIG. 1 is constituted to include a plurality of processor elements (PE) of different types from each other. The processor elements (PE) include a CPU (general purpose processor) 103, a DSP (Digital Signal Processor) 104, and a DRP (Dynamic Reconfigurable Processor) 105. The processor element and a common memory (CM) 102 are coupled in such a manner that signals can be transmitted to each other through a common bus 101 and is formed on one semiconductor substrate such as a single crystal silicon substrate by the well-known semiconductor integrated circuit manufacturing technique. The CPU 103 is a master processor having a task scheduling function and mounts a task manager (TskM) 210 and a basic software (BSoft) 209. The basic software 209 includes an OS (operating system) and a driver of the processor element in the DRP 105.

A task priority table (TA-Pr-T) 808 gives a request of an application software and a task priority of a task corresponding thereto for the heterogeneous multi processor 107, and table information thereof is used for a determination of task scheduling and a criterion of a task selection which will be described below.

FIG. 2 shows a summary of dynamic scheduling in an execution of the application software.

The system apparatus 100 usually executes a task of a preset regular state (RS) 800. The task manager 210 carries out task rescheduling based on various table groups 806. The various table groups 806 include a task priority table (TA-Pr-T) 808, a task management table 809, a hardware model table (H-Modl) 814, and a check point table (TA-CHC) 813 for a task check. Information of the task management table 809 includes a task budget (T-Bu), a task evaluation (T-Ev) and a pass parameter (Parm).

The RS 800 gives a notice of an execution state of a current task to the task manager (TskM) 210 at the time of the end of the task or a check point which will be described below (810). The task manager 210 receiving the notice checks whether an application software is operated in accordance with an executing plan based on a real-time constraint which is first determined on the basis of a check point table (TA-CHC) 813 for the task check, and carries out nothing if the check is excellent. On the other hand, a transition to an irregular state 801 is investigated when an operation is being carried out over a time taken for the executing plan. At this time, reference is made to the task priority table (TA-Pr-T) 808 for the task selection of an IRS 801. Referring to whether the executing plan can be modified through the task to be selected, reference is made to the task management table 809 including a result of an evaluation and a budget of a task and a hardware parameter. At this time, the hardware parameter such as an operating frequency is revised by using a hardware operation model (H-Modl) 814. After the plan is modified, an instruction for executing a task of the IRS 801 is given (802). An instruction for revising the hardware parameter is also given (812).

Also after a transition from the regular state (RS) 800 to the irregular state (IRS) 801, a notice of an execution state of a current task is given (812). If an original executing plan is returned, a reset to the RS 800 is carried out (803).

Next, description will be given to the task scheduling and the operation of the task manager in an execution of the application software by taking the MPEG decoder as an example of the application software.

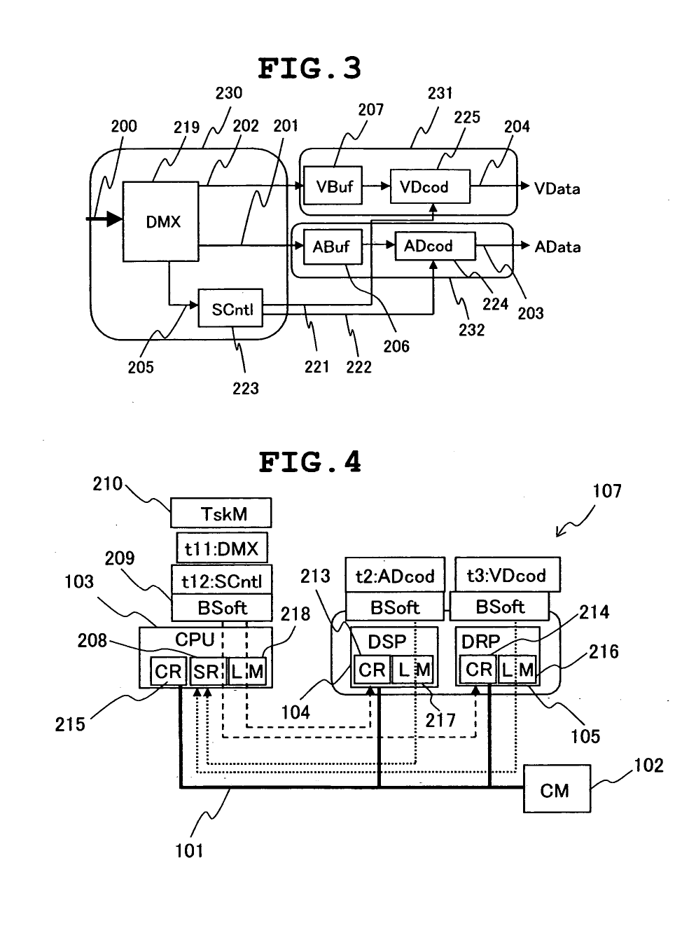

FIG. 3 shows data flor of the MPEG decoder process.

The MPEG decoder shown in FIG. 3 includes a video processing portion 231 for decoding video data, an audio processing portion 232 for decoding audio data, and a control portion 230 for controlling them. The video processing portion 231 includes a video buffer (VBuf) 207 for buffering the input video data and a video decoder (VDcod) 225 for decoding output data thereof. The audio processing portion 232 includes an audio buffer 206 for buffering the input audio data and an audio decoder (ADcod) 224 for decoding output data thereof.

The input data 200 are divided into video data 202 and audio data 201 by a demultiplexer (DMX) 219, and execution timing data of the video decoder (VDcod) 225 and the audio decoder (audio data) 201 are transferred to a system control portion (Scntl) 223. The system control portion 223 transfers timing data 222 and 221 to the video decoder 225 and the audio decoder 224. The video decoder 225 and the audio decoder 224 decode input data corresponding to each other. Output data 204 and 203 of the decoders 225 and 224 are transmitted as VData and AData to a circuit in a subsequent stage which is not shown, respectively.

Next, description will be given to a task execution in a regular state.

FIG. 4 shows the case in which the MPEG decoder illustrated in FIG. 3 is assigned to the heterogeneous multi processor 107.

For example, the demultiplexer (DMX) 219 is assigned as a task t11 on the CPU 103, the audio decoder 224 is assigned to a task t2 on the DSP 104, and the video decoder 225 is assigned to a task t3 on the DRP 105. A data transfer is also assigned as a task in addition to these process module tasks.

In FIG. 4, the CPU 103 functions as a master processor for causing the DSP 104 and the DRP 105 to start the execution of the task and monitoring an execution state. The respective processor elements (PE), that is, the CPU 103, the DSP 104 and the DRP 105 include local memories (LM) 218, 217 and 216 respectively, and the corresponding local memories (LM) are utilized for a process to be closed in the processor element. A data transfer between the processor elements is carried out by using the common bus 101. The common memory (CM) 102 holds only first data and a final result. The CPU 103 starts the task on the processor element through an OS in a basic software (Bsoft) 209. A scheduling plan in the task is stored in a table in the OS. In order to start the task, corresponding control registers (CR) 213, 214 and 215 are used. After a starting instruction is set to the control register (CR), the task on each of the processor elements is started by an interruption process on each of the processor elements or poling. When the task on each of the processor elements reaches an end point or a middle check point, a notice of the purport is given to a status register (SR) 208. After receiving the notice, a task manager (TskM) 210 decides a state of the task. In the decision, if it is decided that the state is poor for the executing plan, a transition to the irregular state 801 is investigated.

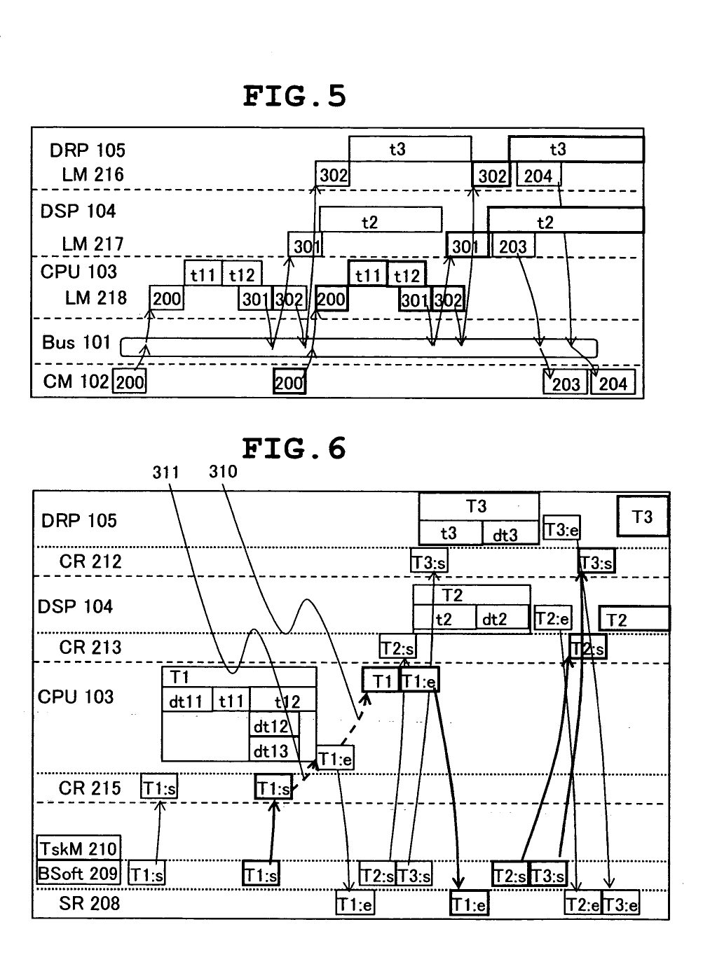

FIG. 5 shows a task control timing in the MPEG decoder.

First of all, the input data 200 shown in FIG. 3 are transferred from the common memory 102 to the local memory 218 through the bus 101. Then, the processes of the tasks t11 and t12 are carried out over the CPU 103, and data 301 and 302 are transferred to the local memories 217 and 216 through the bus 101. The data 301 include the data 201 and 222 in FIG. 3, and the data 302 include the data 202 and 221 in FIG. 3. The DSP 104 and the DRP 105 receiving the data 301 and 302 carry out the processes of the tasks t2 and t3 respectively, and transfer final results 203 and 204 to the common memory 102 through the bus 101.

The process is carried out on a unit referred to as a flame. In the CPU 103, a next flame process is started before one flame process is ended. In the DSP 104 and the DRP 105, a decode process for one flame is ended and decode processes for the second data 301 and 302 are then started.

FIG. 6 shows another task control timing in the MPEG decoder.

Herein, a task control timing chart is shown on the assumption that a transfer source of data is a bus master and has charge of a data transfer task. For only a data transfer to the common memory 102, each of the processor elements is always a bus master in place of the transfer source.

In FIG. 5, a transfer of the data 200 is carried out by the task dt11 of the CPU 103, and a transfer of the data 301 and 302 is carried out by the tasks dt12 and dt13 of the CPU 103. Consequently, the CPU 103 executes a series of tasks dt11, t11, t12, dt12 and dt13. As seen from a master for the task scheduling, they constitute one task of T1. The tasks dt11 and t11 are defined as sub-tasks. Similarly, a task t2 and a sub-task dt2 for transferring the data 203 are combined to constitute a task T2 over the DSP 104 and a task t3 and a sub-task dt3 for transferring the data 204 are combined to constitute a task T3 over the DRP 105.

The basic software 209 for carrying out a task control and the task manager 210 control three tasks of T1, T2 and T3 and monitors a state over the CPU 103. In this example, only the task control is described as the basic software 209 and only state monitoring of the task in a regular state is described for the task manager 210.

First of all, the basic software 209 sets a task T1:s (start) to the control register 215 of the CPU 103 in order to start the task T1. In the CPU 103, the task T1 is started to be executed. When the execution is ended, a task T1:e is set to the status register SR 208. The value is monitored as a task state by means of the task manager 210. The task T1 of a next flame is started before the end of the task T1 in a previous flame. A notice of the end of the task T1 in the previous flame is set as a starting condition of the task T1 in a next flame. When the task T1:e is ended, therefore, a next task T1 is started (311, 310). When the task start 311 is carried out, a wait for the task T1 is released and the next task T1 is started (310). The start and end of the tasks T2 and T3 is also the same. A condition for starting the task is described on a table of an OS as will be described below in detail.

Next, description will be given to the case in which a plan for executing an application software and a revision of the plan are carried out.

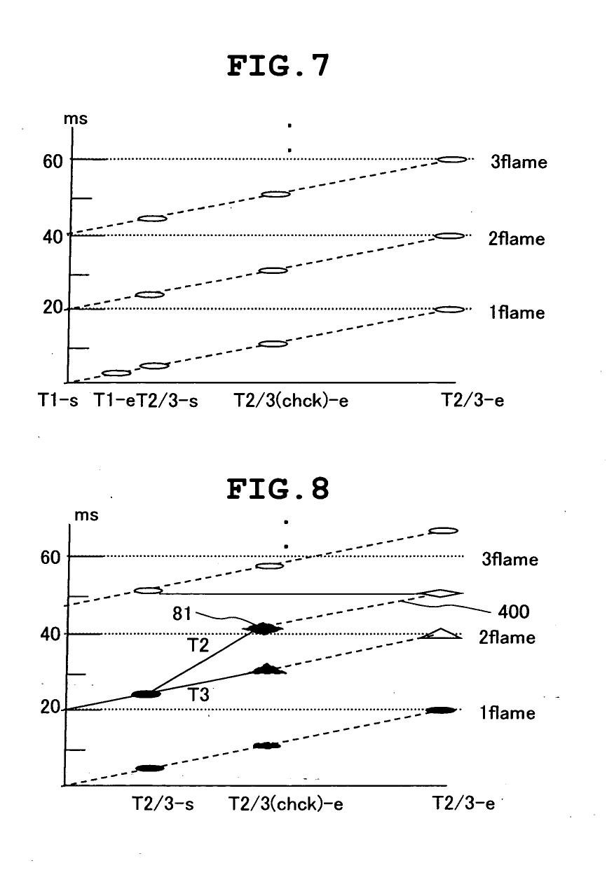

FIGS. 7 and 8 show an example of the plan for executing an application software.

In FIGS. 7 and 8, an axis of abscissas indicates a check point of a task and an axis of ordinates indicates a time. 1 flame on a right of the axis of ordinates represents a flame number. A real-time constraint is determined every flame, and an execution time of approximately 20 ms per flame is set to be a budget. In order to obey the constraint, a middle point is also checked. An ellipse represents an upper limit of a time to be obeyed on the check point of the task. For example, the execution of the task is to be ended before approximately 10 ms on a checkpoint T2/3 (chck)-e for a first flame (1 flame). As the check point, a middle check point of the task execution on T2 (chck)-e and T3 (chck)-e is also determined in addition to T1-e, T2-s, T3-s, T2-e and T3-e. Consequently, a nonarrival of the task at the budget can be monitored in the early stage. The check point will be described below in detail.

As shown in FIG. 7, there is no particular problem if a task execution time is included in the budgets of the execution time. When the executing budget is exceeded as will be described below, however, a transition from the regular state 800 to the irregular state 801 is generated.

In FIG. 8, a rhombus 81 represents that an execution state of a task T2 for a second flame exceeds the budget in a stage of a task T2 (chck)-e. If the fact is disregarded and the execution is continuously carried out as scheduled in the beginning, the task T2 for a second flame is ended at an equal time to the start of the task T2 for a third flame. The start of the task T2 is carried out on the condition of the end of the task T2 of the previous flame. For this reason, there is a high possibility that the start of the task T2 for the third flame might be delayed. In order to avoid the state, it is necessary to investigate a new executing plan by the irregular state 801.

FIG. 9 shows a new executing plan obtained by the irregular state 801. In FIG. 9, a new executing plan for the task T2 for the third flame is shown in an asterisk. The task T3 is the same as that in the regular state 800 (see FIG. 8). The new executing plan of T2 shown in the asterisk is to be processed in an execution time which is a half of the executing plan of T2 in FIG. 8. This is implemented by a task in an irregular state and rescheduling over the task which will be described below in detail.

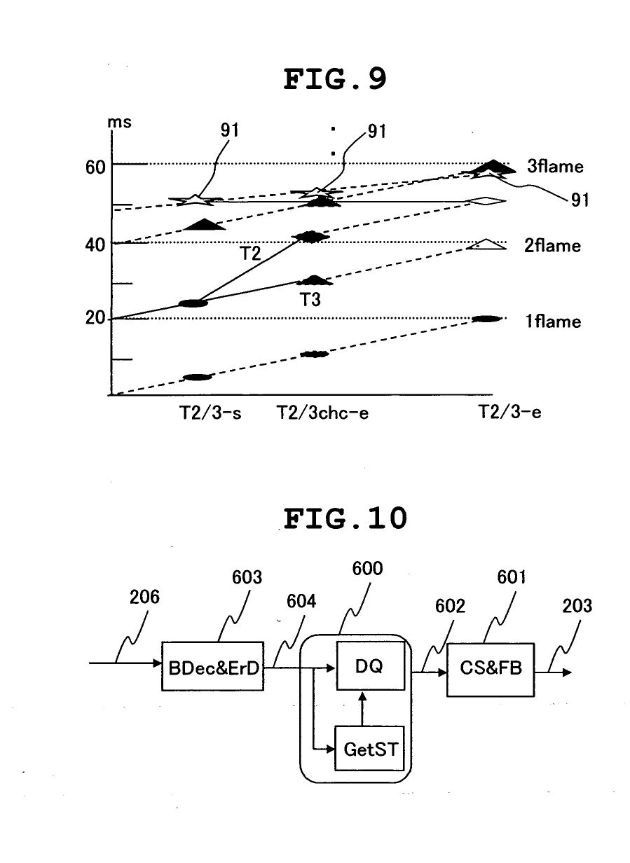

FIG. 10 shows a flow of data on a process constituting the audio decoder 224 which is the process of the task T2.

In a first process (BDec & ErD) 603, an error check for the input data 206 is carried out. Then, flame data are divided into a plurality of data referred to as sub-bands every frequency bandwidth. In a second process 600, thereafter, information referred to as side information is acquired every sub-band (GetST) and a quantization process (DQ) is carried out based on the information. In a third process 601, subsequently, decode results for the respective sub-bands are synthesized (CS) and a filter bank process (FB) is carried out.

A task in the irregular state which implements the decoder 224 is executed in parallel by two processor elements, for example, the CPU 103 and the DSP 104 because the second process 600 is carried out for each sub-band.

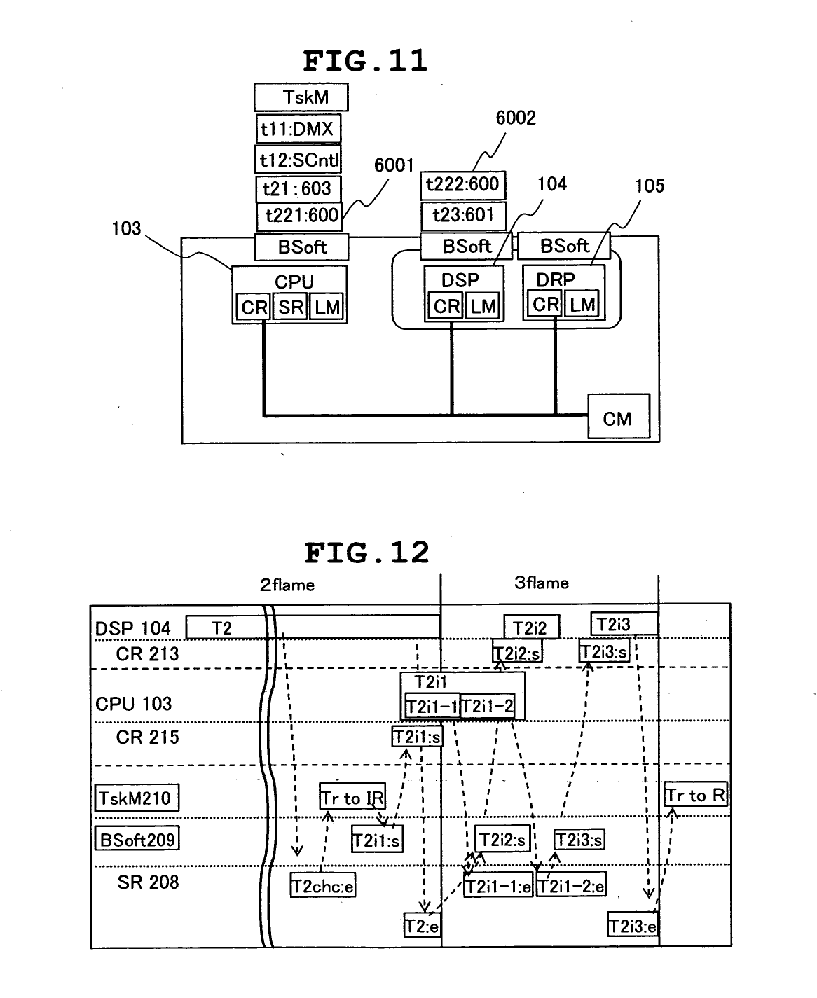

FIG. 11 shows the processor element to be an assignment destination of each process in FIG. 10.

As shown in FIG. 11, the first process 603 is assigned as a t21 task to the CPU 103. In the second process 600, the sub-band is assigned to the CPU 103 and the DSP 104 in a rate of 1:2, for example and is executed as a task t221 in the CPU 103 (6001), and is executed as a task t222 in the DSP 104 (6002). Finally, the third process 601 is executed as a task t23 in the DSP 104.

FIG. 12 shows, in FIG. 9, a task control from a time that the excess of the budget in T2chc-e for the second flame is known to carry out a transition to the irregular state to a time that the irregular task of T2 for the third flame is ended within the budget and is returned again to the regular state T2.

In FIG. 12, a task T2i1 having tasks T2i1-1 and T2i1-2, T2i2 and T2i3 include a sub-task to be processed by each of the processor elements and a sub-task for a data transfer, respectively. In FIG. 12, when the execution of the task T2 is ended in the DSP 104 and the task T2chc:e is set to the status register 208, the task manager 210 carries out an end estimation in the case shown in 400 in FIG. 8 and decides that a budget observation for the third flame might not be achieved because a maximum time budget is exceeded. Therefore, the task manager 210 determines a transition to the irregular state 801 and gives an instruction for stopping the task T2 for the third flame and issuing the irregular task T2i1 of the task T2 for the OS of the basic software 209 (Tr to IR).

Upon receipt of them, the OS sets an irregular task T2i1:s into the control register 215 of the CPU 103 to start the execution of the task T2i1 by the CPU 103. When the execution of T2i1-1 to be a first half part of the task T2i1 is ended, the task T2i1-1:e is set into the status register 208 for the task. By the end of the tasks T2i1-1 and T2 (T2:e), the OS sets the task T2i2:s onto the control register 213 of the DSP so that the execution of the task T2i2 is started. When the execution of the task T2i1-2 is ended, then, the task T2i1-2:e is set onto the status register 208 of the task. Consequently, the OS sets a task T2i3:s onto the control register 213 of the DSP so that the execution of a task T2i3 is started. Upon receipt of an end notice (T2i3:e) of the task T2i3, finally, the task manager 210 confirms the observance of a budget in three flames to carry out a transition to the regular state 800 (Tr to R). More specifically, the task T2i1 is stopped and the task T2 is reissued.

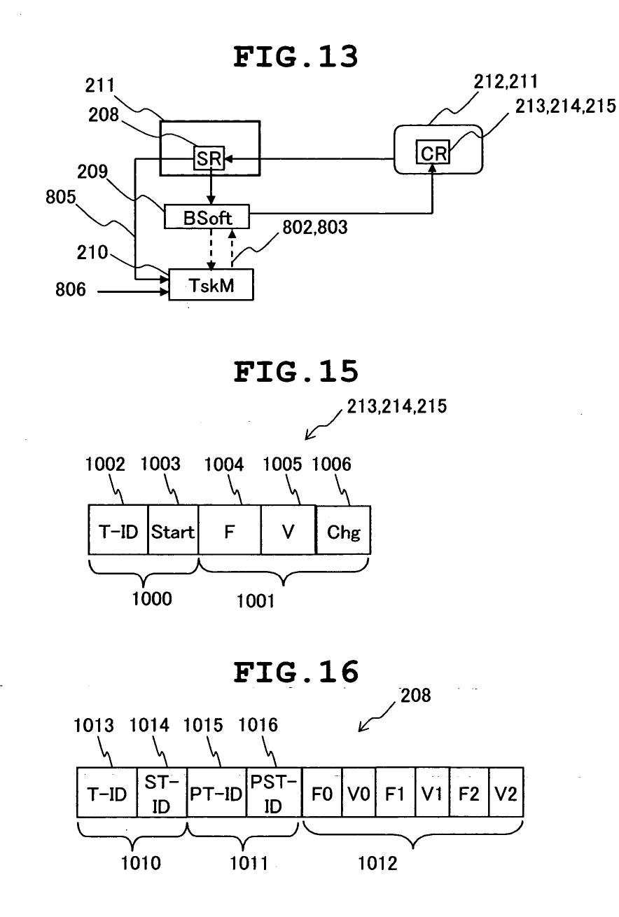

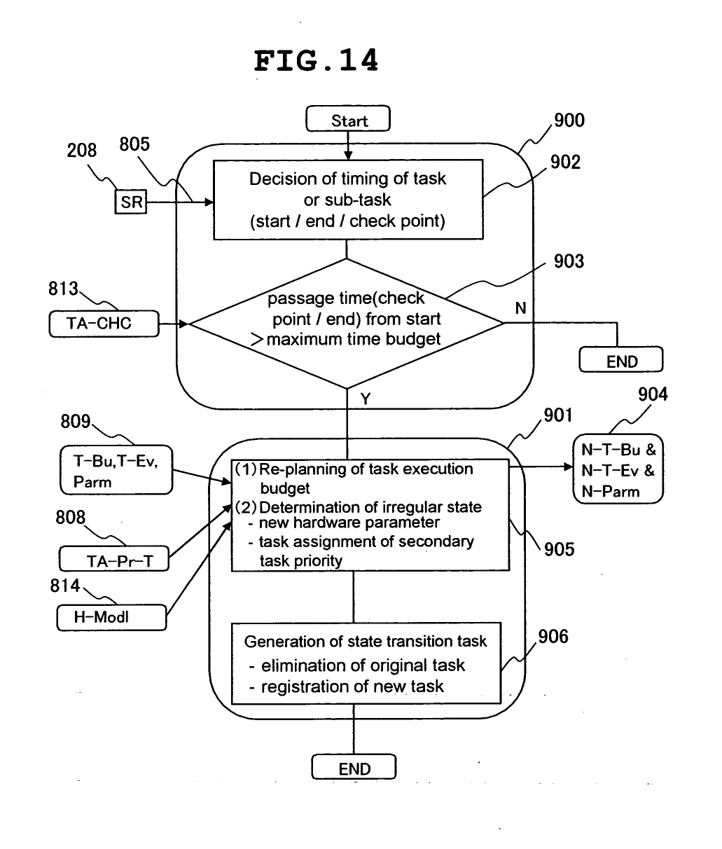

Next, a specific process of the task manager 210 shown in FIG. 2 will be described with reference to FIGS. 13 and 14.

The task manager 210 receives a notice of a state of a task which is being executed in the regular state 800 (810) and checks whether the task is executed in accordance with an executing plan in the beginning or not (see FIG. 7). This process corresponds to a process 900 in FIG. 9. A check point is represented as a task start T2/3-s, a middle check point T2/3 (chck)-e and a task end T2/3-e which are shown in FIG. 7. The check point can be variously set based on a bit 1010 of the status register 208. A data line 805 in FIG. 13 indicates that a notice of the information is given to the task manager 210.

As shown in FIG. 14, a first process 900 and a second process 901 are carried out in the task manager 210.

In the first process 900, first of all, it is decided whether a current state is “start”, “end” or “check point” based on the SR 208 (902). Then, it is decided whether a passage time from the start on this point exceeds a maximum time budget or not (903). The check point is described in the check point table 813. For example, in the task T2, a time that t2fh is ended (which corresponds to a point that the second process 600 is ended) is set to be a middle check point, and a maximum time budget from the start of the execution of the task T2 is 8 msec. In the example shown in FIG. 8, the maximum time budget is exceeded to reach 20 msec. If the task is exactly executed, a budget in a next flame might not be achieved.

In the second process 901 shown in FIG. 14, therefore, the execution of a task in the irregular state 801 is investigated. At this time, an irregular task is expressed in a second task priority based on the task priority table 808. The reason is that there is a possibility that two irregular states might be present. In the example, a first task priority for implementing the audio process 219 is set to be the regular task T2 and a second task priority is set to be a group including the tasks T2i1-1, T2i1-2, T2i2 and T2i3 described with reference to FIG. 12.

The second process 901 includes a determination process 905 in the irregular state 801 and a transition process 906 to the irregular state 801.

In the process 905, first of all, a plan for a task execution budget shown in an asterisk 91 in FIG. 9 is made again. In the process, care is to be taken in such a manner that the budget planning does not cause a task schedule to fail due to an excessive degree of freedom. In the example, when the task schedule fails on the middle check point of the task T2, a plan for including a next flame in a budget is made as shown in FIG. 9. By referring to the task management table 809, then, a new task management table 904 for the irregular state is generated.

More specifically, a task group having a second task priority is set to be a candidate and a new budget T-Bu of the task group is calculated to achieve the plan in FIG. 9, a task candidate for which a new budget can be implemented is searched from the task priority table 808, and a change in a hardware parameter such as a frequency of the task to be the candidate is investigated.

First of all, as shown in FIG. 23, a budget for a current check point (T-ID, ST-ID)=(2, 2) is 8 msec (=8000 μsec) and is added to a task budget for (T-ID)=1 of 5 msec so that the budget is 13 msec in a second flame. However, 20 msec is exceeded at the present time. Therefore, an overtime is 7 msec. A budget for a task of T-ID=2 (T2) generating a delay is 15 msec. For this reason, the execution of the task is to be ended in 8 msec in order to recover the overtime of 7 msec in the next 3 flame. This is a new budget for the task T2.

Next, an implementability of the new budget for the task T2 will be investigated.

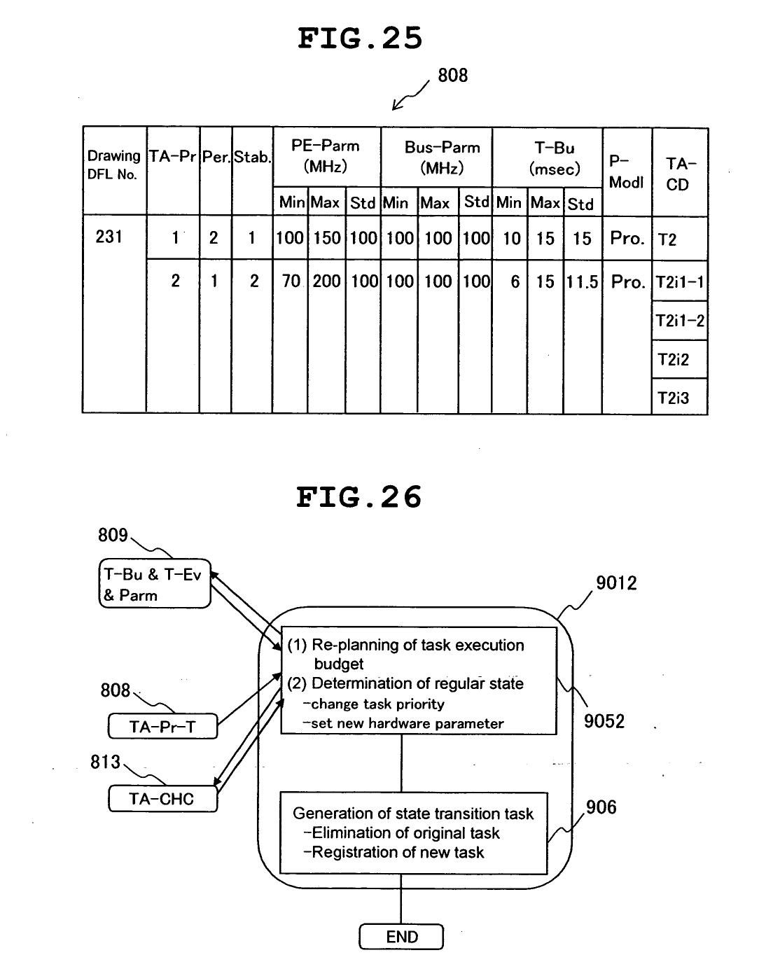

The budget is hard to implement in a task T2 of TA-Pr=1 which is being executed, and might be implemented in a task group of TA-Pr=2. This can be understood from the fact that Min (minimum value) of T-Bu in the task priority table 808 shown in FIG. 25 is 10 msec in the task of TA-Pr=1 which is greater than the budget of 8 msec, and is 6 msec in a task of TA-Pr=2 which is smaller than the budget of 8 msec.

Subsequently, a parameter of a frequency of the task of TA-Pr=2 is determined. The parameter determination includes an approximate determination using the task priority table 808 and a verification of a determination result using the task management table 809 and the hardware operation model 814. This procedure will be described below.

First of all, an approximate value is determined from the task priority table 808. Pro in a term of P-Modl (parameter model) in FIG. 25 indicates that a performance is proportional to a processor element parameter (PE-Parm). A bus parameter (Bus-Parm) is fixed. More specifically, an execution time is inversely proportional to PE-Parm. In the case in which T-Bu of Std in TA-Pr=2 is 11.5 msec and PE-Parm is 100 MHz, therefore, 143.75 MHz (=100 MHz×11.5/8) is obtained in order to implement 8 msec and 150 MHz is obtained if round-up is carried out in a unit of 10 MHz. If a margin of approximately 10% is left to obtain an implementation parameter of 7.2 msec for the budget of 8 msec, the approximate value is 160 MHz in the same manner.

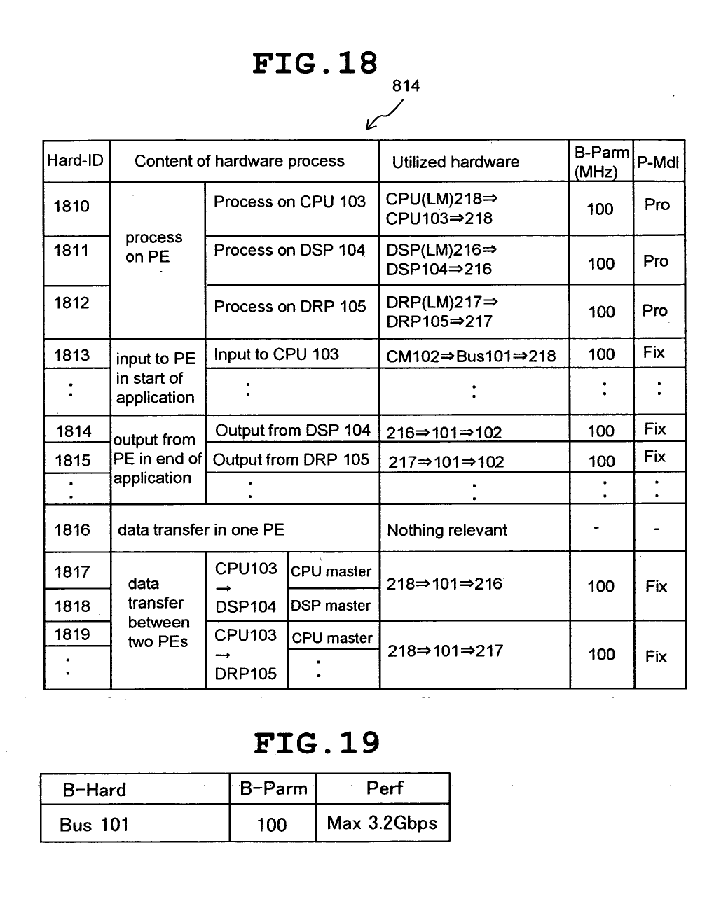

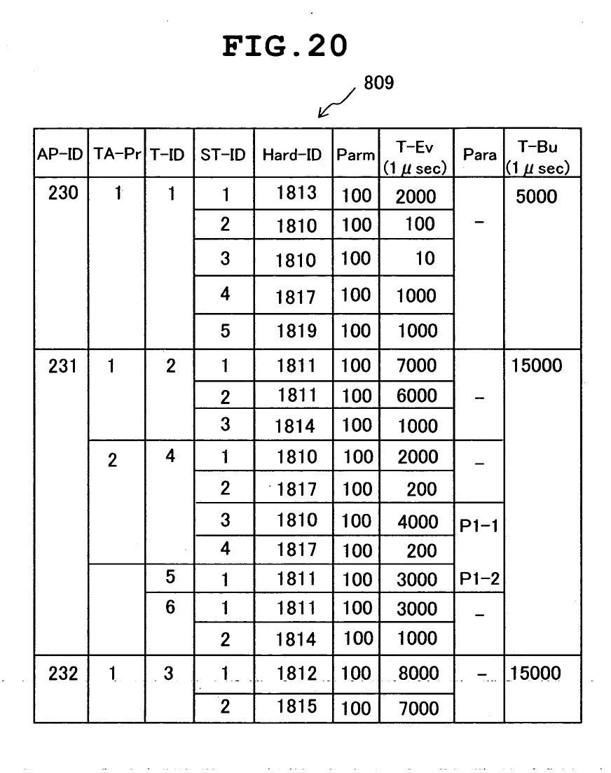

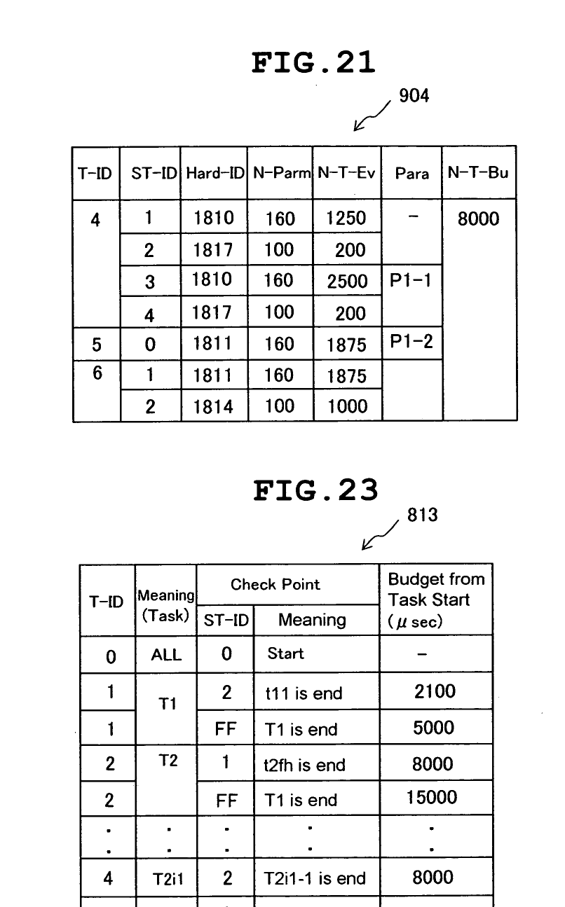

Subsequently, whether the approximate value of 160 MHz is appropriate is verified by using the task management table 809 shown in FIG. 20 and the hardware operation model 814 shown in FIG. 18. According to the task management table 809, a task group of TA-Pr=2 is a target with AP-ID=231. A column of Hard-ID represents a number indicative of any hard resource to be utilized in the hardware operation model 814. FIG. 18 describes a performance characteristic for a parameter every hardware in the same manner as the P-Modl in the task priority table 808. In FIG. 18, a parameter of PE is utilized except for a task utilizing a bus to be a hardware of Fix. FIG. 21 shows a result obtained for only a task group of TA-Pr=2 in a state in which the hardware of Fix is exactly maintained, the parameter of Pro is set to be 160 MHz, and T-Ev in FIG. 20 is caused to be inversely proportional to a frequency. In FIG. 21, a column of Para indicates a task to be processed in parallel in one task, and includes P1-1 and P1-2 as first and second tasks in a parallel P1. In these parallel processes, a greater execution time is taken. In processes other than the parallel processes, all of execution times are added up so that a total of 7.025 μsec (=7.025 msec) is obtained and is smaller than 7.2 msec with a margin of 10% of 8 msec of T-Bu. Therefore, 160 MHz is set to be a new parameter. For the result in FIG. 21, only the management table for AP-ID=231 to bring the irregular state 801 is shown. A result constituted by including AP-ID of the irregular state 801 gives a new task management table 904.

In the transition process 906 to the irregular state 801, a task generation for the OS is carried out. The task is previously registered in the OS. Herein, the task T2 of TA-Pr=1 is stopped and the task group T2i1-1 or T2i3 of TA-Pr=2 is switched from the stoppage to a waiting state. For the task group such as T2i1-1, furthermore, it is necessary to register a value of a frequency through a message box in order to change the frequency. A method of transferring the frequency to the task will be described below in relation to an operation of the OS. A process of issuing and stopping the task for the OS is shown in 802 and 803 in FIG. 13.

When the plan of FIG. 9 is implemented as scheduled, the task manager 210 is returned from the irregular state 801 to the regular state 800. This process is reverse to a transition from the regular state 800 to the irregular state 801, which is not shown. In a stage in which it is known that the budget is obeyed in the decision process 903 of FIG. 14, the task management table is returned from 904 to the task management table 809, the irregular task which is being executed is stopped, and the regular task is returned to a waiting state. A return timing is executed early in the same manner as the return to the irregular state. In FIG. 7, it is confirmed that a check point for a third flame is set as scheduled and a return to a fourth flame is carried out.

Next, description will be given to a register for implementing a task manager operation and a task management table.

Description will be given to the register for implementing the process, the task management table and a table indicative of a task priority.

FIG. 15 shows an example of a format of the control registers CRs 213, 214 and 215 of each processor element. 1000 denotes a region for giving a command for starting a task, T-ID 1002 denotes an ID of a task to be started, and Start 1003 sets a logical value of ‘1’ when the starting is carried out. A value of T-ID will be described below. 1001 denotes a region for giving a command to change a hardware parameter of a processor element, giving a command for a change if the logical value of ‘1’ is set to a Chg 1006, setting a value of a frequency to be changed to an F 1004 and setting a value of a voltage to a V 1005. The F 1004 uses MHz as a unit and the V 1005 uses 0.1 V as a unit. Although only the change of the frequency is described in the example, there is also a possibility that a voltage might be changed in general.

FIG. 16 shows a format of the status register SR 208 provided on the CPU 103 to be the master processor for giving a notice of the task of each processor element and the state of a hardware parameter to the task manager 210.

1010 denotes a state of a task in a current flame and 1011 denotes a state of a task in a previous flame which is executed in parallel. As will be described below, the state of the task in the previous flame is also required for the starting condition of the task. Therefore, the state of the previous flame can also be set. 1012 denotes a value of a current hardware parameter of each processor element. The meaning is the same as a control register.

In 1010, a T-ID 1013 denotes an ID of a task and an ST-ID 1014 denotes an ID for indicating a progress of the task. A logical value of ‘0’ is set by starting the execution of the task. A user sets a sub-task to be a check point through the check point table 813. In 1012, F0 and V0 represent a current frequency and voltage of the CPU 103. F1 and V1 denote an operating frequency and a voltage in the DSP 104, and F2 and V2 denote an operating frequency and a voltage in the DRP 105. A unit is identical in F and V of CR.

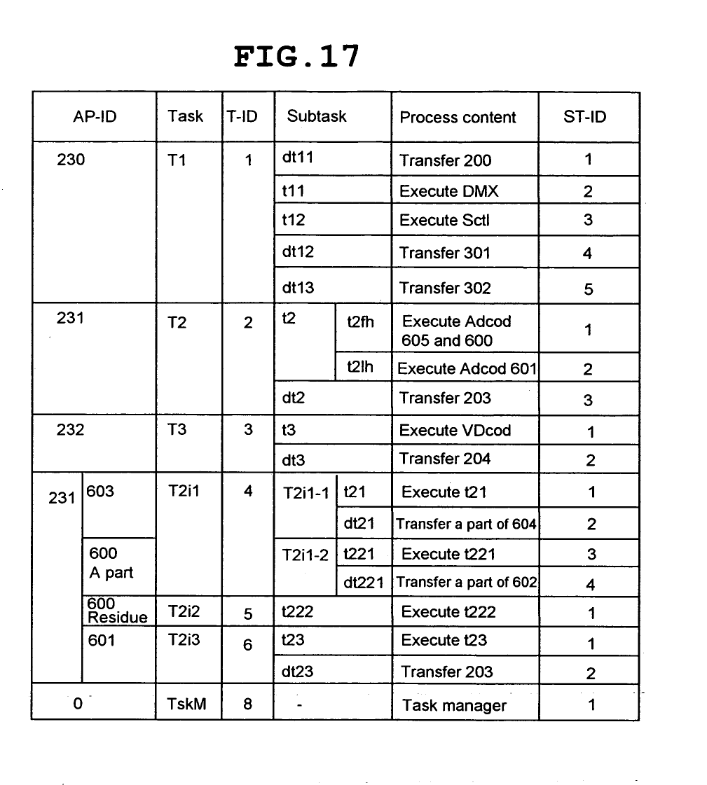

Next, a definition of an ID will be described as a notation of a task and a sub-task with reference to FIG. 17.

In FIG. 17, AP-ID corresponds to the designations in FIGS. 3 and 10 as a correspondence to an application software. A task for implementing the application software includes T1, T2, T3, T2i1, T2i2 and T2i3. In addition, a task which does not correspond to the application software includes a task manager. Referring to the task which does not correspond to the application software, AP-ID is set to have a logical value of ‘0’. For these tasks, T-ID shown in FIG. 17 is defined as an ID. A task related to the application software is further divided into sub-tasks. For example, a task (Task) T1 has, as a sub-task, a sub-task corresponding to the input data 200 shown FIG. 3. For the sub-task, similarly, ST-ID shown in FIG. 17 is defined as an ID.

FIG. 18 shows Hard-ID for dividing a utilized hardware.

The utilized hardware employs a notation of an input hardware → a hardware for implementing a process → an output hardware. For example, a utilized hardware of Hard-ID 1810 implies an application software process on the CPU 103 and implies that data are input from the local memory 218 of the CPU 103, a process is carried out over the CPU 103 and a result is output to the local memory 218.

The contents of the process include an application software process and a data transfer process. The former is a process in a processor element which has Hard-ID of 1810 to 1811 and the latter is a process to be carried out through a bus. The latter includes “an input to a PE (processor element) in a start of an application software” in which data are input from the common memory 102 in the start of the application software, “an output from a PE at an end of an application software” in which data are output to the common memory 102 at the end of the application software, “a data transfer in one PE” and “a data transfer between different PEs”. Referring to the “data transfer in one PE” in the example, only one common memory 102 is provided in each processor element and the transfer cannot be caused. Therefore, nothing is applicable.

The hardware operation model 814 has an object to define a parameter dependency on a characteristic of a hardware corresponding to the Hard-ID shown in FIG. 18. In the example, only a latency to be a hardware characteristic and a frequency to be a parameter are taken. B-Parm is a frequency on an MHz unit to be a basis. On the other hand, P-Md1 denotes a frequency dependency of a performance. Pro implies that a performance is proportional to a frequency and Fix indicates that the frequency is fixed and treated. The performance implies an inverse number of the latency and Pro implies that the latency is inversely proportional to the frequency. In the example, a very simple model is supposed. However, it is also possible to expand a frame and to define a higher advanced model.

FIG. 19 shows a performance limit of the bus 101.

A data transfer of the bus-101 is set to be a maximum of 3.2 Gbps. Since a performance limit in the processor element greatly depends on the contents of a process, it cannot be described independently of a task. For this reason, the performance limit is not covered by the hardware operation model 814.

With reference to FIGS. 20 and 21, next, the task management tables 809 and 904 will be described in detail.

FIG. 20 shows the task management table 809 using a standard hardware parameter related to an application software, and FIG. 21 shows only a portion of the task management table 904 for the irregular state in which a hardware parameter is changed.

In FIG. 20, AP-ID, T-ID, ST-ID and Hard-ID denote a processing portion of an application software, a task, a sub-task and a utilized hardware in accordance with the notation described with reference to FIGS. 17 and 18. For example, there is a task T1 having T-ID of 1 corresponding to AP-ID 230, and the task is constituted by sub-tasks having ST-ID of 1 to 5. A sub-task dt11 with ST-ID having a logical value of ‘1’ utilizes a hardware of Hard-ID 1813 (the common memory 102 → the bus 101 → 218).

There are two types of task groups in which AP-ID executes a process of 231, and a task priority is determined by TA-Pr. A task having a first task priority is T-ID=2 and a task having a second task priority is a combination of T-ID of 4, 5 and 6.

A term of Para indicates a sub-task group for carrying out a parallel process in T-ID, and P1-1 and P1-2 indicate first and second processes of the parallel process 1.

Corresponding to each of the sub-tasks, a standard parameter Parm and an evaluation result T-Ev of the sub-task based on Parm are indicated. Parm indicates a frequency on an MHz unit and T-Ev indicates an execution time on a unit of 1 μsec. Furthermore, a budget T-Bu of a task group for each AP-ID determined by an application software constraint for achieving the executing plan of FIG. 7 is indicated on a unit of μsec.

The task manager 210 carries out the re-planning of a task executing budget and a determination of an irregular state in the second process 901 shown in FIG. 14 by using the task management table having the structure. When the task having a first task priority of T-ID=2 fails, a budget expected for a process of the task group having the second task priority of T-ID=4 to 6 is calculated and how to change the frequency Parm in order to achieve an implementation in the budget is investigated. N-Parm and N-T-Ev in a new management table 904 shown in FIG. 21 is a result of the budget calculation. A task budget having a slight margin is N-T-Bu 8000. In the irregular state 801 subjected to a parameter change, the new task management table of FIG. 21 is used for monitoring an execution state by merging a portion having no change in FIG. 20.

With reference to FIG. 23, next, description will be given to the table check point table 813 for monitoring an executing situation of a task. It is sufficient that the executing situation of the task is checked along T-Ev of the task management table 809. When a large number of check points are present, an overhead is increased. Therefore, the user selects a minimum number of check points from the task management table 809.

FIG. 23 shows an example of a structure of a task check point table. A start (Start) and an end (end) are indispensable to one task. The start is set to be ST-ID=0 for all of task objects. The end is set to be ST-ID for each task. In addition, referring to a task in which a check overhead does not become a problem, an ID of a sub-task ended at an approximately half passage time is registered as ST-ID, and a time that the sub-task is ended is set to be the check point. In FIG. 23, middle check points of a task T2 and a task T2i1 are shown. When a budget from the start of the execution of the task is exceeded, the task manager 210 investigates a transition of the irregular state 801.

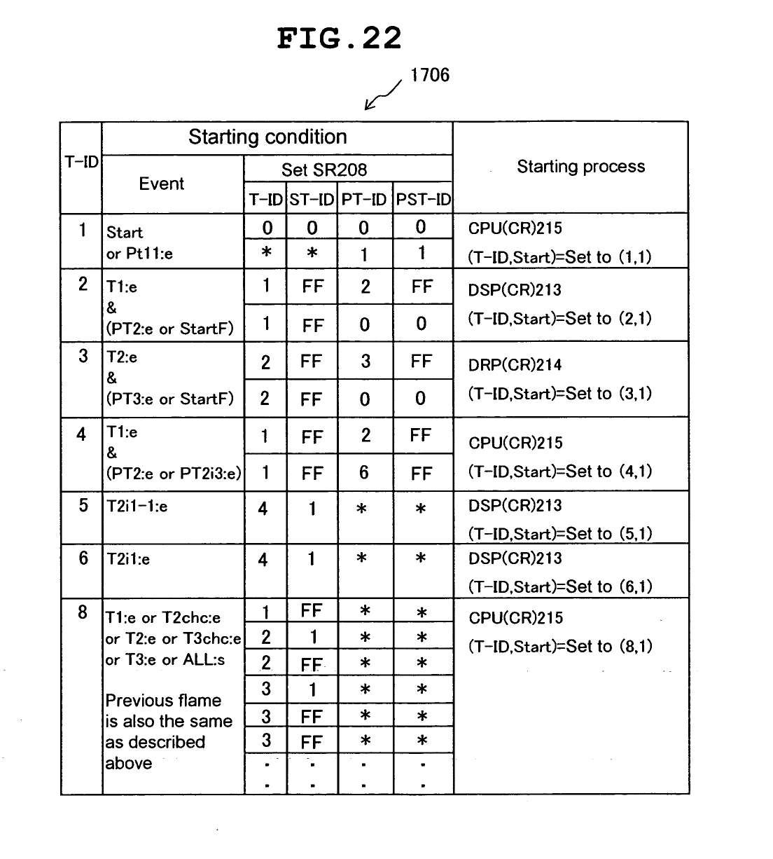

FIG. 22 shows a task management table for an OS to which the OS refers. A table 1706 is not utilized by the task manager 210. A mounting method is varied depending on the OS. Therefore, necessary information for the task management of the OS is described. The table can also be an input for generating a system control program having an OS dependency. In the task management table 1706 for the OS, a starting condition and a starting process are defined for each task ID (T-ID). For the starting condition, an event for each T-ID and a set information value of the status register (SR) 208 are defined (see FIG. 16). The starting condition is decided corresponding to each T-ID, and the OS carries out a process for starting a task. For example, T-ID=1, that is, a starting condition of T1 is a Start time of an application software or t11 of a previous frame, that is, a time that Pt11 is end. In the case in which this is represented by the status register SR 208, the start (Start) can be expressed in (T-ID, Situ, PT-ID, Situ)=(0, 0, 0, 0) and the time that Pt11 is the end is indicated as (*, *, 1, 1). * denotes a logical indefinite. When these conditions are satisfied, the control register 215 of the CPU is set to be (T-ID, Start)=(1, 1). Consequently, a command for starting T1 is given. A process for starting other tasks is carried out in accordance with the starting condition in the same manner.

The process for starting a task depends on mounting. As an example, the process can be executed in the following manner. When receiving a change, the status register (SR) 208 generates an interruption, decides a starting condition in an interruption routine, and gives the OS a notice that the starting condition is satisfied through an event flag. The OS sees the event flag to start a task on a master corresponding to the “starting process”.

At this time, a change in a hardware parameter with a transition of the irregular state depends on a task to be started in the future within the interrupting process, and a current parameter in the SR 208 is compared with the task management tables 809 and 904 to decide a necessity of a parameter change and a hardware parameter, and a value of the region 1001 of the control register is put in a message box. All of the tasks refer to the contents of the message box. As a result, it is also possible to set a value of the region 1001 of the control register which is to be dynamically changed.

FIG. 25 shows an example of a structure of a task priority table (TA-Pr-T) 808.

The task priority table 808 can set a task priority when there is a plurality of tasks for implementing the same process, and at the same time, can qualitatively give a reason for setting the task priority later. In order to carry out rescheduling, a parameter limit of a task and a performance range can also be set in such a manner that an acceptance or rejection for a change in a request and a parameter of a task can be determined.

In the task priority table 808, a qualitative factor for determining a task priority includes a performance Per. and a stability Stab. In addition, other factors such as a power can be considered. Per. indicates a superiority or inferiority of a throughput at an equal frequency and the stability indicates a superiority or inferiority of a degree at which the number of dynamically uncertain elements such a bus competition and an overhead of the OS is decreased and the performance can be obtained stably. In this case, the selection of a task having TA-Pr of 1 indicates that a performance for the same frequency is low (Per.=2), and the number of the dynamically uncertain elements is decreased and an excellent stability can be obtained (Stab.=1). In this example, a task T2 having TA-Pr of 1 is not subjected to the parallel process. Therefore, the bus competition and the uncertain elements of the OS are lessened. Since the process is carried out by one PE, however, a performance for one frequency is lower than that in the parallel process task. On the other hand, task groups of T2i1-1 to T2i3 having TA-Pr of 2 are subjected to the parallel process by a plurality of PEs. Contrary to the task T2, therefore, a large number of uncertain elements are present. However, a performance for one frequency is high.

A quantitative numeral indicates PE-Parm, Bus-Parm and T-Bu. Referring to PE-Parm and Bus-Parm, a minimum value Min and a maximum value Max are set on an MHz unit. In FIG. 25, there is employed a specification in which Bus-Parm is fixed and only PE-Parm is changed. A maximum execution time T-Bu is determined for a minimum frequency PE-Parm and a minimum execution time is determined for a maximum frequency. A maximum value of T-Bu indicates a value of a real-time constraint determined from a request of an application software, and a minimum value (a maximum performance) indicates such a limit that the performance cannot be enhanced any more in order to obey a power budget. The standard value STd. is included between the minimum value and the maximum value, and the user determines a frequency to be standard. A standard value having a first task priority indicates a budget of a task in a regular state which is to be executed normally based on a real-time constraint of an application software request and a value of a parameter.

P-Modl is set in such a manner that an approximate parameter is obtained from the minimum value and the maximum value when the budget is demanded. This indicates an approximate parameter dependency of T-Bu. In FIG. 26, “Pro.” indicates that the performance is proportional to the parameter. More specifically, an execution time is inversely proportional to the parameter.

Next, description will be given to a complier for task scheduling before a system operation.

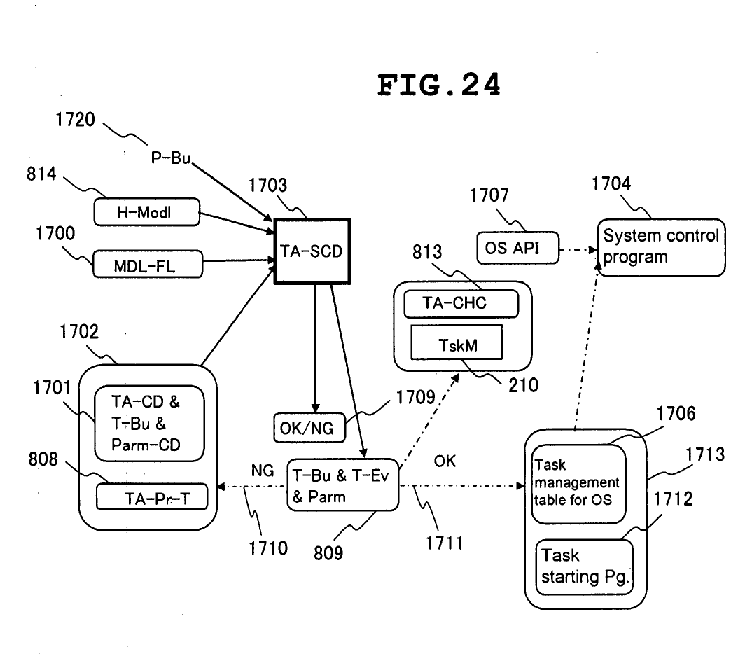

FIG. 24 shows a complier (TA-SCD) 1703 for generating the task management table 809 illustrated in FIG. 20, a procedure for then creating the task management table 1706 for the OS illustrated in FIG. 22, the check point table 813 in FIG. 23 and a task starting Pg. 1712 corresponding to the “starting process” in FIG. 22, and a procedure for creating a system control program 1704 for controlling the OS.

The hardware operation model 814 determined by a hardware, MDL-FL 1700 indicative of only module information of the application software, information 1702 for determining a request of the application software and a task, and a power budget (P-Bu) 1720 are caused to refer to the complier (TA-SCD) 1703. The hardware operation model 814 indicates the hardware characteristic information shown in FIG. 18.

The MDL-FL 1700 is set to be a module table, and the table includes information about a process module of an application software to be a basis of the case in which a task is set up. Based on the information, a division into a plurality of process modules is carried out in the complier 1703 in such a manner that an execution time required for setting up the task is not prolonged and a subdivision is not carried out excessively finely. At this time, referring to a module which can be processed by causing data to be parallel by the same process, the purport is designated. Furthermore, a data transfer amount of the input/output of the process module and the designation of a module of a data transfer destination are also added as auxiliary information about a task division.

The information 1702 for determining a request of an application software and a task includes information 1701 for giving a candidate to be a task as an initial input of the task management table 904 from the process module, and the task priority table 808 for giving a task priority of a task in consideration of the request of the application software and the characteristics of the task.

The information 1701 to be given as the initial input of the task management table designates a candidate of a sub-task having the process module designated by the MDL-FL 1700 which is united together with a hardware ID (Hard-ID) to be utilized, and at the same time, also designates a candidate for a standard parameter S-Parm of a frequency. A candidate for the task obtained by setting up the sub-task is also designated. In the table, the sub-task in the task management table 809 is described on a module unit which is divided in more detail.

The task priority table 808 sets a task priority when there is a plurality of tasks for implementing the same process in the information 1701. The task priority is set based on a qualitative selection in an early stage, and a quantitative budget value is set in consideration of the result of the process obtained by the TA-SCD 1703. The power budget (P-Bu) 1720 indicates a maximum value through a power budget of the whole heterogeneous multi processor. This is utilized for defining an upper limit of a frequency when the task priority table 808 is manually specified. In the TA-SCD 1703, a power calculation in the execution of a task through a certain PE is carried out and the power budget (P-Bu) 1720 is used as a constraint for deciding whether the task is included in the power budget or not.

By using the various table information, the TA-SCD 1703 carries out scheduling for the task. It is checked whether a real-time observance can be carried out and a data transfer exceeds a maximum rate of a bus or not in accordance with the candidate which is set manually. As a result, the evaluation result T-Bu is output together with a result 1709. If the result is not desirable (NG 1710), the candidate 1701 can be manually changed along an arrow 1710.

If the result of the process obtained by the TA-SCD 1703 has no problem (OK 1711), a starting condition for a task and a check condition which are determined are taken into consideration to create a task management table 1706 for the OS, the check point table 813, the starting Pg. 1712 of the PE task corresponding to the task on the master OS which corresponds to a starting process for each task ID shown in FIG. 22 and the task manager 210 shown in FIG. 14.

Then, the system control program 1704 is created. The task management table 1713 for the OS, the task starting Pg. 1712 to be a task on the master OS, and an API 1707 of a peculiar even flag to the OS and a message box which implements to set the starting condition and the frequency parameter shown in FIG. 22 are combined to create an input.

Next, description will be given to a specific structure for flexibly corresponding to the case in which an application software request is changed after the system apparatus 100 is shipped or when the same application software is to be loaded onto different system apparatuses.

In the example, as shown in FIG. 1, the contents of the task priority table 808 are changed with a variation in the application software request. As a result, the task management table 809 and the check point table 813 are also reconstructed newly, and a task for starting the OS normally is also changed.

The processing is implemented by changing a mode of the process 901 (see FIG. 14) to be carried out by the task manager 210. Since the mode is different, the process is distinguished as 9012 for convenience in FIG. 26.

It is assumed that an audio decoder process of 231 is a real-time constraint of 9 msec as a new request of the application software. The request is less than 15 msec of a Max value of T-Bu in FIG. 25 which is a past request, and has a higher performance. Furthermore, the request is also less than Min of T-Bu of the past standard task T2 shown in FIG. 25. Therefore, the request cannot be implemented in the task. Even if the tasks T2i1-1 to T2i3 are used, the execution cannot be achieved because of T-Bu of 11.5 msec in a parameter of Std. which is currently determined.

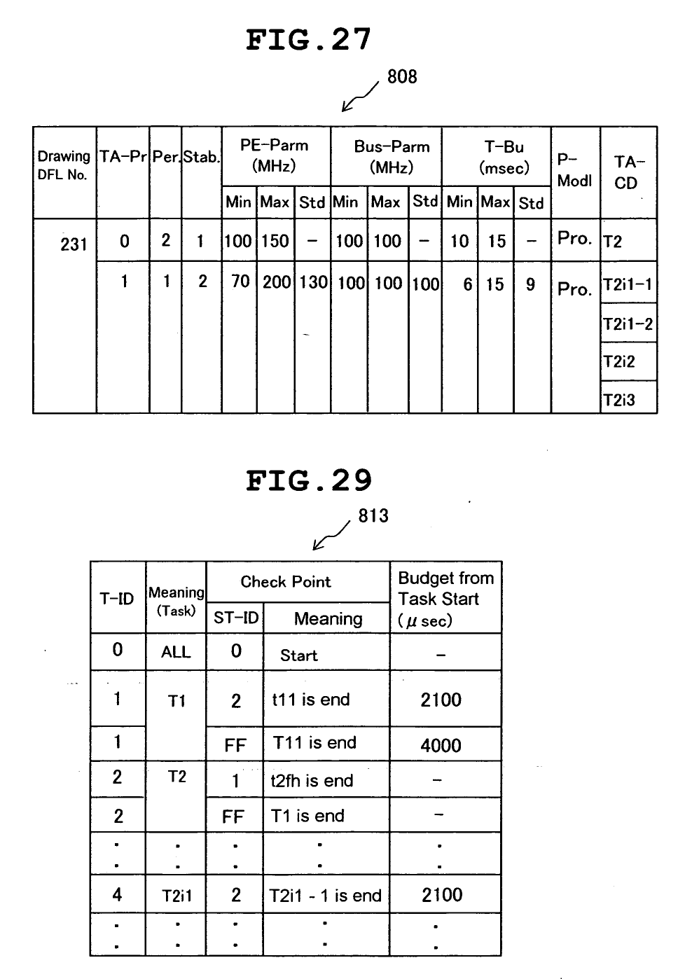

As shown in FIG. 27, therefore, the contents of the task priority table (TA-Pr-T) 808 are changed. Since the task T2 cannot be executed, TA-Pr is set to be 0 and TA-Pr is set to be 1 for the tasks of T2i1-1 to T2i3. Std of T-Bu with TA-Pr of 1 is set to be 9 msec which is an application software request and a value of PE-Parm is set to be 130MHz by an inversely proportional calculation based on the past Std.

A process 9012 shown in FIG. 26 includes a first process 9052 and a second process 906.

In the first process 9052, a new task priority table 808 is input and reference is made to the task management table 809, thereby checking an implementability of T-Bu of 9 msec together with a propriety of PE-Parm determined temporarily to revise the task management table 809 and the task priority table 808. Furthermore, the data of the check point table 813 are also derived newly from the task priority table 808. The first process 9052 is almost the same as the process 5. The process 5 serves to determine the irregular state, while the process 9052 serves to set the regular state. For this reason, they are directly set to the task management table 809 and the check point table 813.

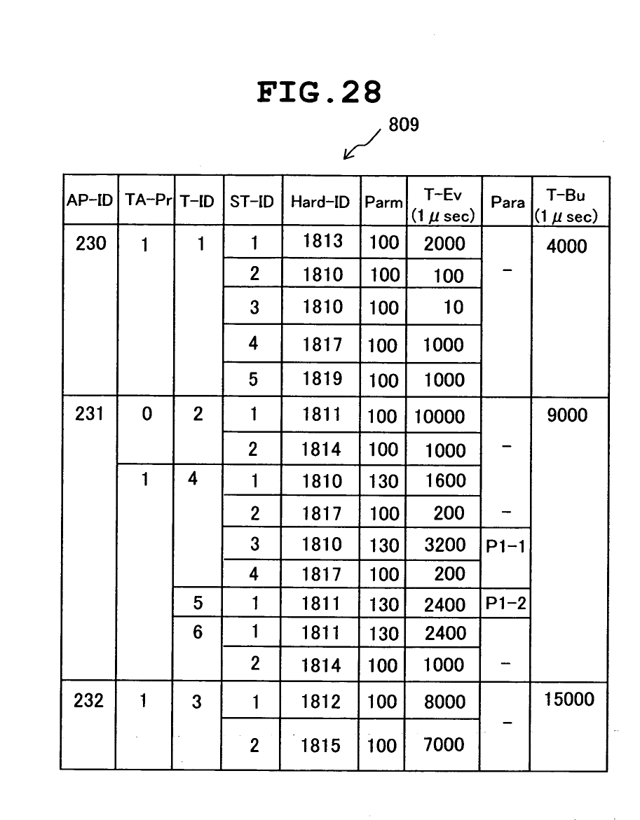

FIG. 28 shows a result of an update of the task management table 809.

Since T2 of T-ID=2 cannot be executed, TA-Pr is set to be 0 and a task group of T-ID=4, 5 and 6 is set to cause TA-Pr to have a logical value of ‘1’. A task budget (T-Bu) is set to be 9000 μsec (=9 msec) in accordance with the task priority table 808. A bus parameter (Parm) is set to be 130 MHz in accordance with the task priority table 808 for each of (T-ID, ST-ID)=(4, 1), (4, 3), (5, 1) and (6, 1) to which the processor element is related, and a value of an evaluation result T-Ev of a sub-task is calculated. As a result of the calculation, a result 7600 obtained by adding the values of T-ID=4 and T-ID=6 is a latency in consideration of a parallel property. For the value, a budget of 9000 has a margin of 18% (which is calculated by dividing 9000 by 7600) which is decided to be sufficient.

FIG. 29 shows a result of an update of the table check point table 813. The check point is not changed but only a budget value for carrying out a check on a checkpoint is revised. For example, a maximum time budget on a check point 1 of T-ID=4 is set to have a slight margin on 1800 obtained by adding T-Ev for (T-ID, ST-ID)=(4, 1) and (4, 2) from the result of FIG. 28. In FIG. 29, 2100 is set in consideration of a degree of a margin of 18% in the calculation of FIG. 28.

From the foregoing, the task management table 809 and the check point table 813 can be set. They are not contradictory to the result of the task priority table 808. This respect is visually checked. If there is no problem, an elimination of an original task and a registration of a new task are carried out from the result of the task management table 809 in accordance with the second process 906 for a transition to the irregular state 801. In the example, the task T2 is stopped and the tasks T2i1-1 to T2i3 are brought into an execution state.

According to the example, it is possible to obtain the following functions and advantages.

(1) The task manager 210 carries out task rescheduling based on various table groups 806. Referring to the various table groups 806, the RS 800 gives a notice of an execution state of a current task to the task manager (TskM) 210 at an end of a task or a time of a check point which will be described below. The task manager 210 receiving the notice checks whether or not an application software is operated according to an executing plan based on an initial determined real-time constraint based on the check point table (TA-CHC) 813 for a task check, and carries out nothing if a result of the check is excellent. On the other hand, if an operation is being carried out over a time required for an executing plan, a transition to the irregular state 801 is investigated. At this time, reference is made to the task priority table (TA-Pr-T) 808 for a task selection of the IRS 801. Referring to whether the executing plan can be modified through the selected task or not, reference is made to the task management table 809 constituted by an evaluation result and budget of a task and a hardware parameter. In this case, the hardware parameter such as an operating frequency is revised by using the hardware operation model (H-Modl) 814. After the plan is modified, a command for a task execution of the IRS 801 is given (802). A command for revising the hardware parameter is also given. Thus, dynamic scheduling in an execution of an application software is carried out by the task manager 210.

(2) By the functions and advantages in (1), also in the case in which an application software request is changed after a system apparatus is shipped and in the case in which the application software request is not satisfied according to a budget in the beginning by a dynamic factor, it is possible to flexibly correspond to the application software request.

While the invention made by the inventor has been specifically described above, it is apparent that the invention is not restricted thereto but various changes can be made without departing from the scope thereof.

Although the invention made by the inventor has been mainly described for the case in which a heterogeneous multi processor to be a utilization field that is a background thereof is applied to a car navigation system, it can be widely applied to various multi processors and application systems thereof.

The invention can be applied on at least a condition that an application software is executed by a plurality of processor elements.

What is claimed is:

1. A multi processor including a plurality of processor elements and capable of executing an application software by the processor elements, comprising:
a processing portion for carrying out a process for determining a task to be assigned to the processor elements at a request given from the application software.

2. A multi processor including a plurality of processor elements and capable of executing an application software by the processor elements, comprising:
a plurality of tasks in which assignments of processes to the processor elements are different from each other; and
a task manager for selecting a task corresponding to a request given from the application software from the tasks.

3. The multi processor according to claim 2, further comprising:
a task management table including the task, a sub-task constituting the task, a budget of an execution time of the sub-task and an evaluation result, and a hardware parameter having a hardware code for implementing the sub-task and an operating frequency; and
a hardware model including a substance of the hardware parameter and information about a correlation between the hardware parameter and the execution time,
the task manager carrying out task scheduling based on the task management table and the hardware model.

4. The multi processor according to claim 2, wherein the task manager decides an implementability based on the task management table and the hardware model table after a change of the task based on the request given from the application software and changes the hardware parameter or carries out a change to a task having a lower task priority than a current task if it is decided that the request given from the application software is not satisfied in the decision.

5. A task scheduling method in a multi processor capable of executing a software process of an application software on a unit of a task by an assignment to a plurality of processor elements, comprising the step of:
changing an assignment of a task assigned to the processor elements based on a task priority table indicative of a task priority for the tasks.

6. The task scheduling method according to claim 5, wherein the task priority table includes a hardware parameter for executing the task together with task priority information for the tasks.

7. The task scheduling method according to claim 6, wherein whether an execution time request is satisfied is decided by using a task management table for a task management and a hardware model table for hardware model information, and a hardware parameter for implementing an execution time which is demanded is recalculated by using the task management table and the hardware model table corresponding to a result of the decision.

8. The task scheduling method according to claim 6, wherein there is selected, as a new task, a change of a hardware parameter having a first task priority based on the task priority table if a request for an execution time is changed during an execution of the task having the first task priority, or a task having a second task priority or less which is selected and an execution to be achieved by the hardware parameter if the selection of the task having the second task priority or less and a change of a parameter of a hardware to execute the task satisfy an application software request.

9. The task scheduling method according to claim 7, wherein when an execution time request of an application software is defined on a process data unit, a time exceeding a first budget is subtracted from an original budget with respect to a second task to determine a task execution time so as not to exceed a budget of a task for a next second process data unit if an execution of a check point of a task exceeds the budget for a first process data unit based on a task check point table holding a middle check point of the task and a budget of the check point.
